(19) United States
(12) Patent Application Publication
(10) Pub. No.: US 2016/0274738 A1
(43) Pub. Date: Sep. 22, 2016

(54) DISPLAY METHOD USING VIRTUAL WIDGET AND ASSOCIATED DEVICE

(71) Applicant: MediaTek Inc., Hsin-Chu (TW)

(72) Inventors: Chih-Hsiang Hsiao, Taipei City (TW); Chi-Hsuan Lin, New Taipei City (TW); Pei-Lun Suei, Taichung City (TW); Po-Yu Chen, Zhubei City (TW)

(21) Appl. No.: 14/993,343

(22) Filed: Jan. 12, 2016

Related U.S. Application Data
(60) Provisional application No. 62/135,324, filed on Mar. 19, 2015.

(51) Int. Cl. G06F 3/0481; G06T 13/80; G06T 11/00

(52) U.S. Cl. CPC G06F 3/0481; G06T 11/00; G06T 13/80

(57) ABSTRACT

A display method using a virtual widget, an associated electronic device, and an integrated circuit are provided. The electronic device includes: a display; a plurality of sensors, a first control system; and a second control system having a controller. The first control system offloads display workloads to the second control system before the first control system has entered the sleep mode. The controller receives sensor data from the sensors and executes a virtual widget based on information of the received sensor data when the first control system has entered the sleep mode.

### CROSS REFERENCE TO RELATED APPLICATIONS

This application claims the benefit of U.S. Provisional Application No. 62/135,324, filed on Mar. 19, 2015, the entirety of which is incorporated by reference herein.

### BACKGROUND OF THE INVENTION

1. Field of the Invention

The invention relates to an electronic device, and, in particular, to a display method using a virtual widget and an associated electronic device.

2. Description of the Related Art

With recent advances in technology, mobile devices have become more and more popular. When the mobile device is a smart watch, it is necessary to display a clock on the screen all the time. In addition, sensors on the mobile device may also keep gathering sensor data all the time. However, it may consume much power to keep displaying the always-on clock or to process sensor data from the sensors in a conventional mobile device, resulting in lower battery time of the mobile device.

Accordingly, there is demand for a display method, an associated electronic device, and an associated circuit to solve the aforementioned problem.

### BRIEF SUMMARY OF THE INVENTION

A detailed description is given in the following embodiments with reference to the accompanying drawings.

An electronic device is provided. The electronic device comprises: a display; a plurality of sensors, a first control system; and a second control system comprising a controller. The first control system offloads display workloads to the second control system before the first control system has entered a sleep mode. The controller receives sensor data from the sensors and executes a virtual widget based on information of the received sensor data when the first control system has entered the sleep mode.

A display method using a virtual widget in an electronic device is provided. The electronic device comprises a display, a plurality of sensors, a first control system, and a second control system. The method includes the steps of: offloading display workloads of the first control system to the second control system before the first control system has entered a sleep mode; and receiving sensor data from the sensors and executing a virtual widget based on information of the received sensor data by the second control system when the first control system has entered the sleep mode.

A circuit is provided. The circuit comprises: a first control system; and a second control system, comprising a controller, wherein the first control system offloads display workloads to the second control system before the first control system has entered a sleep mode; wherein the controller receives sensor data and executes a virtual widget based on information of the received sensor data when the first control system has entered the sleep mode.

### BRIEF DESCRIPTION OF THE DRAWINGS

The invention can be more fully understood by reading the subsequent detailed description and examples with references made to the accompanying drawings, wherein:

FIG. 1 is a diagram of an electronic device in accordance with an embodiment of the invention;

FIG. 2 is a block diagram of the electronic device in accordance with an embodiment of the invention;

FIGS. 3A-3C are diagrams illustrating images for different events in accordance with an embodiment of the invention;

FIG. 3D is a diagram illustrating the virtual widget layer in accordance with an embodiment of the invention;

FIG. 3E is a diagram illustrating the system-level layer in accordance with an embodiment of the invention;

FIG. 3F is a diagram illustrating the resulting output image generated by the OSD circuit in accordance with an embodiment of the invention;

FIGS. 4A-4C are diagrams illustrating animation images of an analog clock in accordance with an embodiment of the invention;

FIG. 5 is a flow chart of a low-power optimization method in accordance with an embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

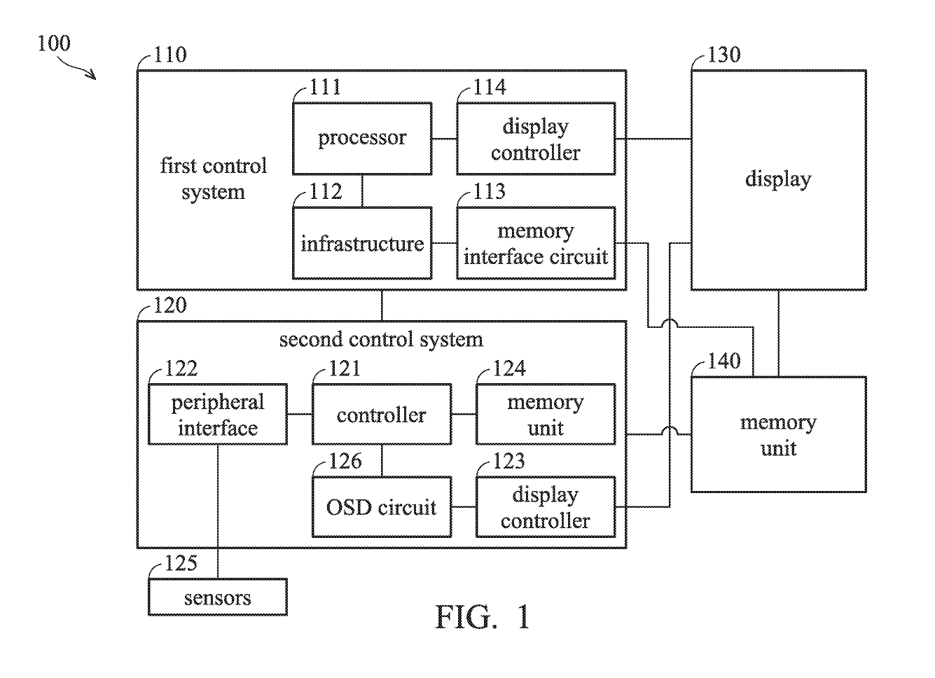

FIG. 1 is a diagram of an electronic device 100 in accordance with an embodiment of the invention. The electronic device 100 comprises a first control system 110, a second control system 120, a display 130, and a memory unit 140. The first control system 110 provides an execution environment for running applications using more system resources in a rich application mode. The second control system 120 provides a platform for controlling the peripherals connected to the electronic device, such as sensors 125, touch control module (not shown), speakers (not shown), etc., but the invention it not limited thereto. The second control system 120 also provides a low-power execution environment for running applications or performing operations which use very limited system resources. It should be noted that the first control system 110 and the second control system 120 share the display 130, and the details will be described later.

In this embodiment, the first control system 110 comprises a processor 111, an infrastructure 112, a memory interface circuit 113, and a display controller 114. The processor 111 may be a central processing unit (CPU), a digital signal processor (DSP), or the like. The infrastructure 112 is an intermediary (e.g., a system bus and/or an interface circuit) communicating between the processor 111, the memory interface circuit 113, the display controller 114 and the second control system 120. The memory interface circuit 113 provides a memory interface communicating between the processor 111 and the memory unit 140. The memory unit 140 is connected to the processor 111 through the memory interface circuit 113. In some embodiments, the memory interface circuit 113 can be omitted, and the memory unit 140 is directly connected to the processor 111 through the infrastructure 112. The display controller 114 is configured to control the display timing and generate the display data to the display 130.

For example, the memory unit 140 may comprise a non-volatile memory and a volatile memory, e.g., DRAM (not shown in FIG. 1). The volatile memory may be applied as a main memory for the processor 111 for executing software routines and other selective storage functions. The non-volatile memory, such as a flash memory, is capable of holding instructions and data without power and may store the software routines for controlling the electronic device 100 in the form of computer-readable program instructions.

The display 130 is connected to the first control system 110 through the display controller 114. The display 130, for example, can be implemented by liquid crystal display (LCD), light-emitting diode (LED), or organic light-emitting diode (OLED) technologies, but the invention is not limited thereto. In some embodiments, the display 130 can be integrated with a touch control module, so that the user may control the electronic device 100 via touch actions on the display 130. The processor 111 may display a first user interface on the display 130 through the display controller 114.

The second control system 120 comprises a controller 121, a peripheral interface 122, a display controller 123, a memory unit 124, and an on-screen-display (OSD) circuit 126. For example, the memory unit 124 may be a volatile memory such as an SRAM or a tightly-coupled memory. The memory unit 124 may be applied as a main memory for the controller 121 for executing software routines and other selective storage functions. In addition, the memory unit 124 may also be a frame buffer that stores still images or animation images for rendering. Alternatively, the memory unit 140 is coupled to the controller 121 and the memory unit 140 can also be the frame buffer that stores still images or animation images for rendering. The controller 121, for example, may be a microcontroller or a processor, but the invention is not limited thereto. In the embodiment, the display 130 is also connected to the second control system 120 through the display controller 123. In some embodiments, the display controller 123 can be disposed externally to the second control system 120.

In an embodiment, a plurality of sensors 125 is coupled to the controller 121 via the peripheral interface 122. The sensors 125, for example, comprise at least one of a pedometer (e.g., accelerometer and gyroscope), an ambient light sensor, a proximity sensor, and the like. The sensors 125 are connected to the controller 121 through the peripheral interface 122 such as SPI, UART, or SDIO interface. In addition, other types of peripheral devices can also be connected to the controller 121 through the peripheral interface 122, such as a timer device, a touch control module, a speaker, a network device, etc. For example, the controller 121 may receive incoming mails or messages from the network device (e.g., using Bluetooth Low Energy (BLE) protocol) through the peripheral interface 122. In an embodiment, the peripheral interface 122 is implemented by a sensor hub for receiving signals detected by the sensors 125.

In an embodiment, the components 111-114 of the first control system 110 can be regarded as an application (AP) system, and are integrated into a single chip. The components 121-124 of the second control system 120 can be regarded as a microcontroller (MCU) system, and are also integrated into another chip. In an alternative embodiment, the components of the AP system and the MCU system can be integrated into a system-on-chip (SoC). Alternatively, the first control system 110 and components 121 and 126 of the second control system 120 can be integrated into a single chip.

In an embodiment, when the first control system 110 enters a sleep mode, the components (e.g., 111-114) of the first control system 110 may also be turned off to save power. Meanwhile, components (e.g., 121-126) of the second control system 120 and the components (e.g., sensors 125, display 130, and the network device) connected to the second control system 120 are still running. Since the power consumption of the second control system 120 is much lower than that of the first control system 110, the second control system 120 takes over the control of the electronic device 100 when the first control system 100 (e.g., an AP sub-system) enters the sleep mode. For example, given that the electronic device 100 is a smart watch, the second control system 120 may execute a clock application for rendering an always-on clock on the display 130 and to keep updating the time shown on the clock while the first control system 110 enters the sleep mode. In the embodiment, the clock shown on the display 130 can be divided into different image layers such as a clock background image, an hour-hand image, a minute-hand image, and a second-hand image. That is, the controller 121 has to update the second-hand image every second, update the minute-hand image every minute, and update the hour-hand image every hour. In the embodiment, virtual widget scripts are executed by the controller 121 for updating the image layers of the clock shown on the display 130, and the details will be described later. It should be noted that a widget is a function with a window that displays on a smart watch to show some information.

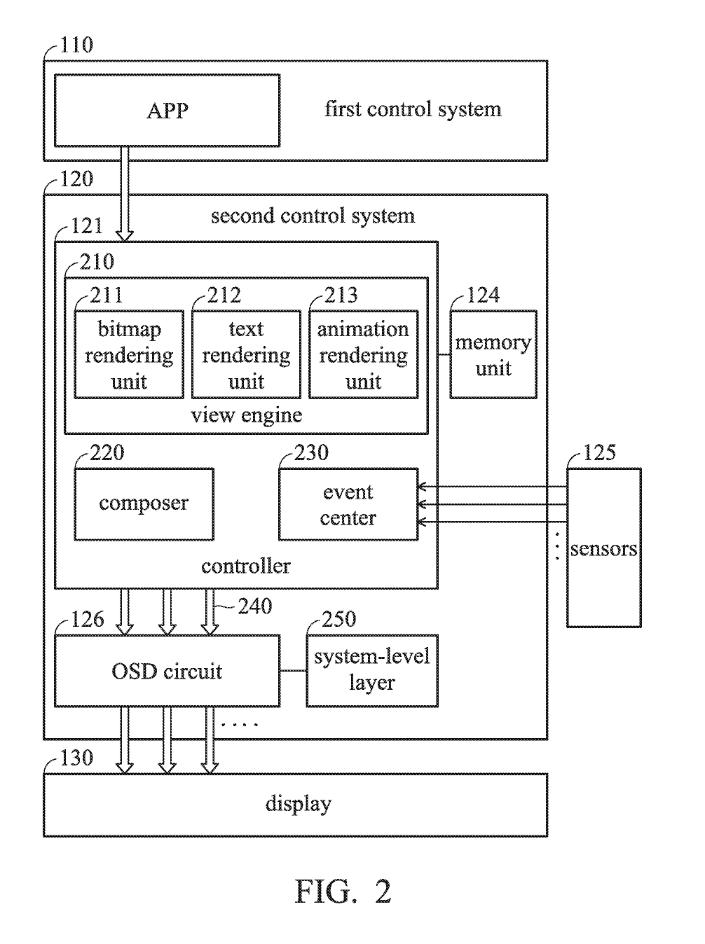

FIG. 2 is a block diagram of the electronic device in accordance with an embodiment of the invention. For illustrative purposes, in FIG. 2, the first control system 110 is shown as an AP system, and the second control system 120 is shown as a platform. Before the first control system 110 has entered the sleep mode, the controller 121 may retrieve program codes of the virtual widget scripts, and associated images and scripts from the first control system 110. The retrieved program codes, images (e.g., including still images and/or animation images), and scripts can be stored in the memory unit 124 of the second control system 120. Thus, the controller 121 may access the required program codes of the virtual widget scripts and/or the images from the memory unit 124. In an embodiment, if the storage space of the memory unit 124 is sufficient to store the program codes of the virtual widget scripts and the images, the memory unit 140 can be turned off to save power consumption. In an alternative embodiment, if the storage space of the memory unit 124 is only enough to store a portion of the program codes of the virtual widget scripts and the images, the controller 121 may retrieve the remaining program codes and images from the memory unit 140 when necessary.

There are several modules in the virtual widget such as a view engine 210, a composer 220, and an event center 230. The view engine 210 is configured to render images, texts, and/or animation images on the display 130. In addition, the view engine 210 is further configured to generate view information for the received events and/or animations, and implement key functions on the platform. In an embodiment, the view engine 210 comprises a bitmap rendering unit 211, a text rendering unit 212, and an animation rendering unit 213. The bitmap rendering unit 211 may retrieve the images (e.g., including still images, icons, text, or animation images) to be shown on the display 130 from the memory unit 124 (e.g., the retrieved image is in a bitmap format).

The composer 220 is configured to compose the events and/or animation images into frames. The event center 230 is configured to receive events from sensors 125 and/or hardware circuits, e.g., real-time clock. For example, the sensors 125 may periodically or non-periodically send detected sensor data to the event center 230, and the event center 230 may execute event-triggered tasks accordingly based on the received sensor data. For example, the pedometer/step counter (not shown) in the sensors 125 may detect motions or heart beats of the user, and send the detected sensor data to the event center 230. The event center 230 may analyze the sensor data from the sensors 125, and determine the associated walking or running speed, walking distance, or the heart rate of the user. Then, the event center 230 may inform the view engine 210 to draw images of associated text or icons to be rendered on the display 130, and the composer 220 may compose all image layers generated by the view engine 210 into a virtual widget layer 240. The OSD circuit 126 may compose the virtual widget layer 240 and the system-level layer (e.g., Android layers) 250 to generate the resulting output image to be shown on the display 130. In some embodiments, the system-level layers can be stored in the memory unit 124 before the first control system 110 has entered the sleep mode. In some other embodiments, the controller 121 may execute a simple operating system for updating the information of the system-level layers which are stored in the memory unit 124.

For example, the background image of the resulting output image is drawn by the operating system, e.g., Android or IOS, and the background image may illustrate notifications such as current date, received text messages, incoming mails, weather, etc., but the invention is not limited thereto.

In addition, the real-time clock may also periodically send an update signal to the event center 230, e.g., 1 second once, and thus the event center 230 may inform the view engine 210 to update the bitmap images of the clock shown on the display 130.

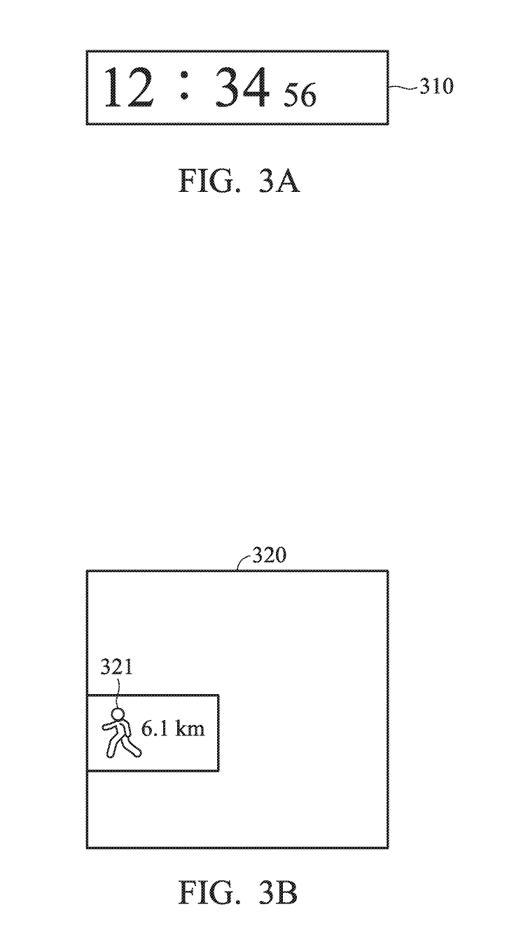

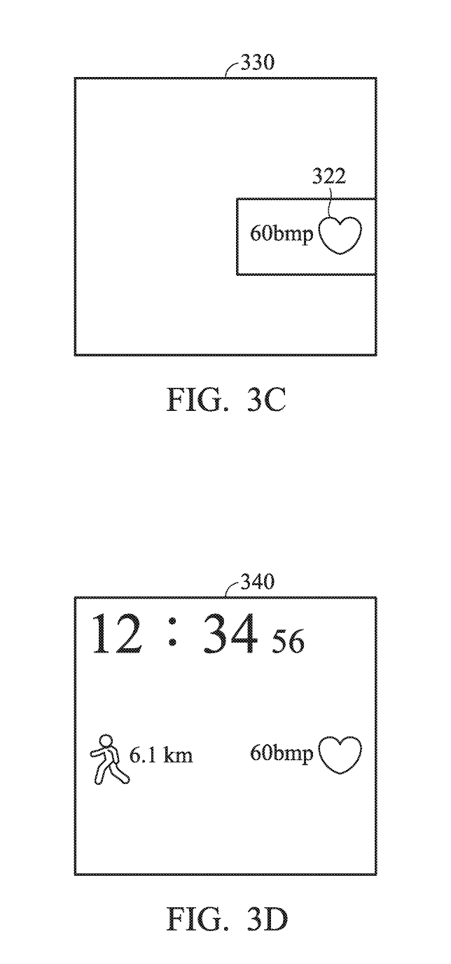

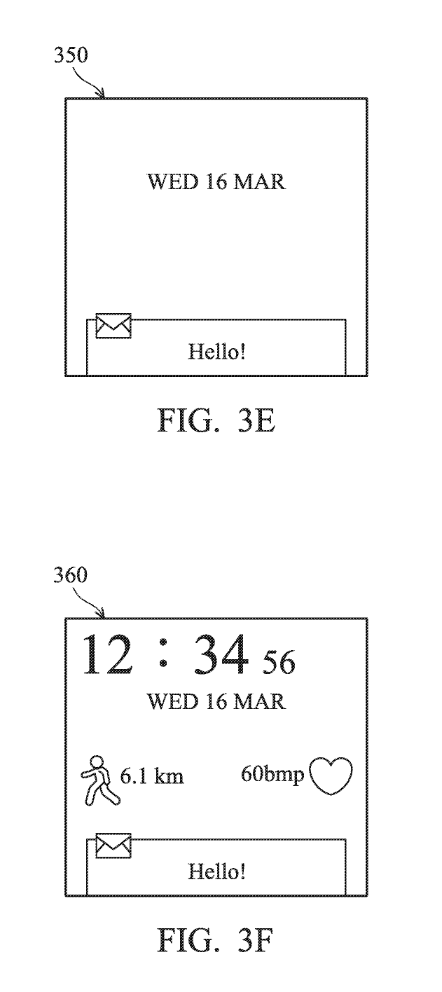

FIGS. 3A-3C are diagrams illustrating images for different events in accordance with an embodiment of the invention. Referring to both FIG. 2 and FIG. 3, the event center 230 may periodically receive current time information and an update signal from the real-time clock, e.g., 1 second once, and then inform the view engine 210 to draw the image 310 associated with the received current time, as shown in FIG. 3A. In addition, the event center 230 may also periodically or non-periodically receive sensor data from the sensors 125, e.g., pedometer/step counter, heart rate sensor . . . etc., and determine the current heart rate, e.g., 60 beats per minute, and the distance that the user has walked, e.g., 6.1 km. Then, the event center 230 may inform the view engine 210 of determined current heart rate and the distance, and the view engine 210 may retrieve the associated icons 321 and 322 for the distance and the heart rate from the memory unit 124, respectively. Subsequently, the view engine 210 may draw the retrieved icon 321 and the value of the distance on the frame 320, as shown in FIG. 3B, and draw the retrieved icon 322 and the value of the current heart rate on the frame 330, as shown in FIG. 3C.

FIG. 3D is a diagram illustrating the virtual widget layer in accordance with an embodiment of the invention. FIG. 3E is a diagram illustrating the system-level layer in accordance with an embodiment of the invention. FIG. 3F is a diagram illustrating the resulting output image generated by the OSD circuit in accordance with an embodiment of the invention. All frames 310, 320, and 330 generated by the view engine 210 are transmitted to the composer 220. It should be noted that the frames 310, 320, and 330 are for illustrating information and have a relatively low resolution compared with that of the resulting output image. The composer 220 may arrange the content of the frames 310, 320, and 330 to predetermined locations of the virtual widget layer 340, as shown in FIG. 3D.

The system-level layer 350, as shown in FIG. 3E, may include information about current date, incoming text messages, and/or incoming emails, but the invention is not limited thereto. Furthermore, the OSD circuit 260 may integrate the virtual widget layer 340 from the composer 220 and the system-level layer 350 (shown in FIG. 3E) from the operating system of the first control system 110 to generate the resulting output image 360 (assuming a digital clock is used), as shown in FIG. 3F. The resulting output image may include all the information of the frames 310, 320, and 330, and also include the system information in the system-level layer 350. It should be noted that the aforementioned operations can be performed by the second control system 120 while the first control system 110 has entered the sleep mode, so that the information provided to the user can be maintained.

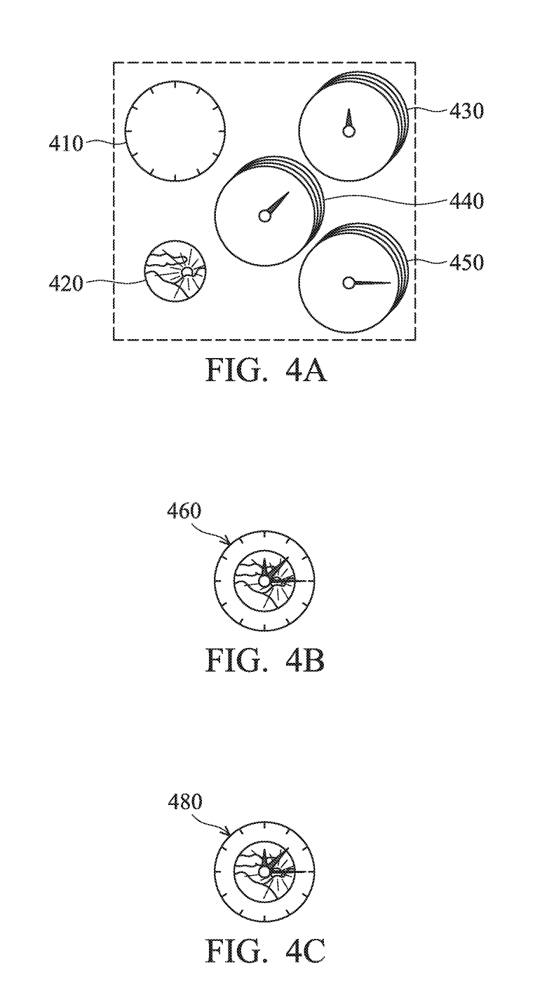

FIGS. 4A-4C are diagrams illustrating animation images of an analog clock in accordance with an embodiment of the invention. Referring to FIG. 2 and FIGS. 4A-4C, the second control system 120 may display an analog clock on the display 130 when the first control system 110 has entered the sleep mode. To illustrate the analog clock, a plurality of animation images are required. For example, images of the clock face, clock background, and hands are required. Before the first control system 110 has entered the sleep mode, the second control system 120 retrieves the scripts (or program codes) and images associated with the analog clock from the first control system 110, and saves the retrieved scripts and images into the memory unit 124. For example, the retrieved images for the analog clock includes a clock-face image 410, a clock background image 420, a plurality of hour-hand images 430, a plurality of minute-hand images 440, and a plurality of second-hand images 450, as shown in FIG. 4A. In some embodiments, the hour-hand images, minute-hand images, and second-hand images can be integrated into various time images to represent different times of the day. The event center 230 may receive the current time information from the real-time clock, and calculate the position and angle of clock hands associated with the current time information. Then, the event center 230 may inform the view engine 210 to retrieve the images associated with the current time information from the memory unit 124. Then, the composer 220 may arrange the retrieved images (e.g., the hour-hand image, minute-hand image, and second-hand image) with a designated layout to generate a virtual widget layer 460, as shown in FIG. 4B. In the embodiment, the OSD circuit 126 may integrate the virtual widget layer 460 from the composer 220 and the system-level layer from the operating system of the first control system 110 to generate the resulting output image 480, as shown in FIG. 4C. In some embodiments, the system-level layer will be ignored by the OSD circuit 126 when a full-screen analog clock is rendered on the display 130. It should be noted that the operations in the embodiments in FIGS. 3A-3F and FIGS. 4A-4C can be combined. For example, the analog clock can be rendered with the information from the sensors 125 (e.g., frames 310-330 in FIGS. 3A-3C).

It should also be noted that the second control system 120 may update partial information shown on the display 130 when the determined status is changed or a new incoming notification is received. For example, if the user starts running at a certain time point, the heart rate and distance may change accordingly. The second control system 120 may only update information related to heart rate and distance, without updating other information. Similarly, since the current time information always changes over time, the second control system 120 has to update the current time information every second. Then, the second control system 120 only has to update the current time information (e.g., frame 310) shown on the display 130 without updating other information. Specifically, the processor 121 may update the content of the partially-updated information in the display buffer, e.g., memory unit 124, so that other content of the resulting output image is not changed, and thus power consumption can be minimized.

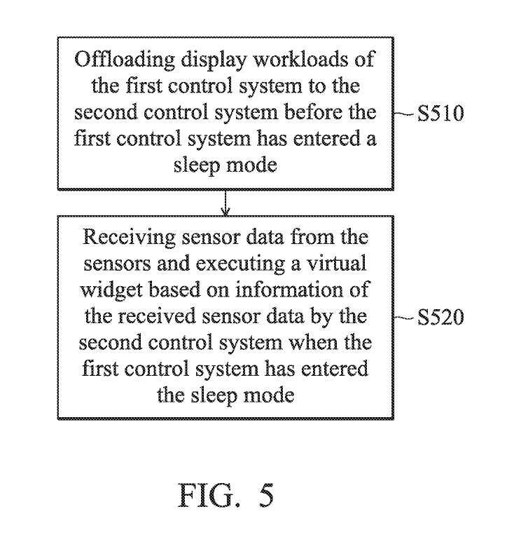

FIG. 5 is a flow chart of a display method using a virtual widget in an electronic device in accordance with an embodiment of the invention. In step S510, display workloads of the first control system are offloaded to the second control system before the first control system has entered a sleep mode. In step S520, the second control system receives sensor data from the sensors and executes a virtual widget based on information of the received sensor data when the first control system has entered the sleep mode. For example, the received sensor data may be from the sensor and/or hardware (e.g., current time information from the timer), and the execution of the virtual widget can be based on the information of the received sensor data and/or the current time information.

In view of the above, a display method using a virtual widget and an associated electronic device are provided. Specifically, the second control system takes control of the display when the first control system (e.g., an application system) has entered the sleep mode. Since there are very limited system resources available to the second control system, and there are concerns over power consumption, the second control system (e.g., a low-power MCU system) may retrieve scripts and images to be used on the virtual widget from the first control system before the first control system has entered the sleep mode, and then execute the scripts of the virtual widget after the first control system has entered the sleep mode. Accordingly, the second control system may maintain the display of an always-on clock on the display with low power consumption by updating the hand images every second even if the first control system has entered the sleep mode. With the help of the OSD circuit, the virtual widget layer and the system-level layer can be integrated, and thus the user may also view the system information on the display.

Furthermore, the invention also discloses a circuit, comprising a first control system and a second control system having a controller. The first control system offloads display workloads to the second control system before the first control system has entered a sleep mode. The controller receives sensor data and executes a virtual widget based on information of the received sensor data when the first control system has entered the sleep mode. The controller receives sensor data and executes a virtual widget based on information of the received sensor data when the first control system has entered the sleep mode. Preferably, the controller retrieves scripts and images to be used on the virtual widget from the first control system and saves the retrieved scripts and images into a memory unit of the second control system when the first control system is offloading the display workloads to the second control system. Preferably, the virtual widget comprises a view engine, configured to render bitmaps, text, and/or animation of the retrieved images; an event center, configured to receive current time information and the sensor data from the sensors, and analyze the received current time information and sensor data to estimate motion of a user of the electronic device; and a composer, configured to integrate the rendered bitmaps, text, and animation from the view engine to generate a virtual widget layer. Preferably, the second control system further comprises an on-screen-display circuit, configured to integrate the virtual widget layer and a system-level layer to generate a resulting output image to be displayed on the display. Preferably, the second control system further comprises an on-screen-display circuit configured to on-screen-display an analog clock.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a display;
a plurality of sensors;
a first control system; and
a second control system, comprising a controller,
wherein the first control system offloads display workloads to the second control system before the first control system has entered a sleep mode;
wherein the controller receives sensor data from the sensors and executes a virtual widget based on information of the received sensor data when the first control system has entered the sleep mode.

2. The electronic device as claimed in claim 1, wherein the first control system and the second control system share the display.

3. The electronic device as claimed in claim 1, wherein the controller retrieves scripts and images to be used on the virtual widget from the first control system and saves the retrieved scripts and images into a memory unit of the second control system when the first control system is offloading the display workloads to the second control system.

4. The electronic device as claimed in claim 3, wherein the second control system further comprises a real-time unit for periodically generating current time information, and the controller further executes the virtual widget based on the information of the received sensor data and/or the time information when the first control system has entered the sleep mode.

5. The electronic device as claimed in claim 4, wherein when the virtual widget renders a digital clock, the retrieved images comrise images of numbers of a digital clock, and the controller integrates and displays the retrieved images of numbers associated with the current time information on the digital clock.

6. The electronic device as claimed in claim 4, wherein when the virtual widget renders an analog clock, the retrieved images comprise hand images, a clock background image, and a clock-face image of an analog clock, and the controller integrates and displays the retrieved hand images, clock background image, and clock-face image associated with the current time information on the analog clock.

7. The electronic device as claimed in claim 4, wherein the virtual widget comprises:
a view engine, configured to render bitmaps, text, and/or animation of the retrieved images;
an event center, configured to receive current time information and the sensor data from the sensors, and analyze the received current time information and sensor data to estimate motion of a user of the electronic device; and
a composer, configured to integrate the rendered bitmaps, text, and animation from the view engine to generate a virtual widget layer.

8. The electronic device as claimed in claim 7, wherein the controller renders icons and text of the estimated motion on the virtual widget layer, and the estimated motion comprises a heart rate and walking distance of the user.

9. The electronic device as claimed in claim 7, wherein the second control system further comprises: an on-screen-display circuit, configured to integrate the virtual widget layer and a system-level layer to generate a resulting output image to be displayed on the display.

10. The electronic device as claimed in claim 9, wherein the system-level layer comprises notifications of current date, text messages, incoming mails, weather, or a combination thereof.

11. A display method using a virtual widget in an electronic device, wherein the electronic device comprises a display, a plurality of sensors, a first control system, and a second control system, the method comprising:
offloading display workloads of the first control system to the second control system before the first control system has entered a sleep mode; and
receiving sensor data, by the second control system, from the sensors and executing a virtual widget based on information of the received sensor data when the first control system has entered the sleep mode.

12. The display method as claimed in claim 11, further comprising:
retrieving scripts and images, by the second control system, to be used on the virtual widget from the first control system and saving the retrieved scripts and images into a memory unit of the second control system when the first control system is offloading the display workloads to the second control system.

13. The display method as claimed in claim 12, wherein the second control system further comprises a real-time unit for periodically generating current time information, and the display method further comprises:
executing the virtual widget based on the information of the received sensor data and/or the time information when the first control system has entered the sleep mode.

14. The display method as claimed in claim 13, wherein when the virtual widget renders a digital clock, the retrieved images comprise images of numbers of the digital clock, and the second control system integrates and displays the retrieved images of numbers associated with the current time information on the digital clock.

15. The display method as claimed in claim 13, wherein when the virtual widget renders an analog clock, the retrieved images comprise hand images, a clock background image, and a clock-face image of the analog clock, and the second control system integrates and displays the retrieved hand images, clock background image, and clock-face image associated with the current time information on the analog clock.

16. The display method as claimed in claim 13, wherein the virtual widget comprises:
a view engine, configured to render bitmaps, text, and/or animation of the retrieved images;
an event center, configured to receive current time information and the sensor data from the sensors, and analyze the received current time information and sensor data to estimate the motion of the user of the electronic device; and
a composer, configured to integrate the rendered bitmaps, text, and animation from the view engine to generate a virtual widget layer.

17. The display method as claimed in claim 16, wherein the second control system further comprises: an on-screen-display circuit, configured to integrate the virtual widget layer and a system-level layer to generate a resulting output image to be displayed on the display.

18. A circuit, comprising:
a first control system; and
a second control system, comprising a controller.
wherein the first control system offloads display workloads to the second control system before the first control system has entered a sleep mode;
wherein the controller receives sensor data and executes a virtual widget based on information of the received sensor data when the first control system has entered the sleep mode.

19. The circuit as claimed in claim 18, wherein the controller retrieves scripts and images to be used on the virtual widget from the first control system and saves the retrieved scripts and images into a memory unit of the second control system when the first control system is offloading the display workloads to the second control system.

20. The circuit as claimed in claim 18, wherein the virtual widget comprises:
a view engine, configured to render bitmaps, text, and/or animation of the retrieved images;
an event center, configured to receive current time information and the sensor data from the sensors, and analyze the received current time information and sensor data to estimate motion of a user of the electronic device; and
a composer, configured to integrate the rendered bitmaps, text, and animation from the view engine to generate a virtual widget layer.

21. The circuit as claimed in claim 20, wherein the second control system further comprises an on-screen-display circuit, configured to integrate the virtual widget layer and a system-level layer to generate a resulting output image to be displayed on the display.

22. The circuit as claimed in claim 18, wherein the second control system further comprises an on-screen-display circuit configured to on-screen-display an analog clock.
